(19) United States
(12) Patent Application Publication
(10) Pub. No.: US 2015/0105024 A1
(43) Pub. Date: Apr. 16, 2015

(54) Bluetooth Communication and Multimedia Device of a Shower Column

(71) Applicant: Jie-Fu Chen, Chiayi City (TW)

(72) Inventor: Jie-Fu Chen, Chiayi City (TW)

(21) Appl. No.: 14/053,937

(22) Filed: Oct. 15, 2013

(51) Int. Cl. H04W 84/18

(52) U.S. Cl. CPC H04W 84/18
USPC 455/41.3

(57) ABSTRACT

A bluetooth communication and multimedia device of a shower column contains: a body including a showing unit, a bluetooth receiving device pairing with a bluetooth system built in a cellular phone by ways of bluetooth; a display interface unit connecting with the bluetooth receiving device; and a conversion communication unit secured on the display interface unit and having an answering unit. The bluetooth communication and multimedia device also contains a music transforming unit disposed on the display interface unit and having a playing unit; an email unit mounted on the display interface unit; an audio unit fixed on the display interface unit; a clock alarming unit secured on the display interface unit; a controlling unit disposed in the body and controlling the bluetooth receiving device, the display interface unit, the conversion communication unit, the music transforming unit, the email unit, the audio unit, and the clock alarming unit.

### BACKGROUND OF THE INVENTION

1. Field of the Invention

The present invention relates to a bluetooth communication and multimedia device of a shower column in which a bluetooth receiving device of a body receives a calling signal by using a cellular phone or a tablet computer in a bluetooth wireless transmission manner, and the body provides information services so that a user answers a call or shifts to a music playing mode to play music based on using requirement.

2. Description of the Prior Art

Conventional showering equipment contains a plurality of shower heads mounted on a showering column, and the plurality of shower heads are fixed on the showering column at different heights so as to correspond to user's head, shoulder, neck, back, waist, hip, and legs. After shifting a switch, water sprays out of the plurality of shower heads to wash and massage the user's body.

However, the showering column still has the following defects: a cellular phone will become wet if being sprayed by water during taking a shower. The showering column is not provided with bluetooth answering function, so it cannot answer a call.

The present invention has arisen to mitigate and/or obviate the afore-described disadvantages.

### SUMMARY OF THE INVENTION

The primary object of the present invention is to provide a bluetooth communication and multimedia device of a shower column in which a bluetooth receiving device of a body receives a calling signal by using a cellular phone or a tablet computer in a bluetooth wireless transmission manner, and the body provides information services so that a user answers a call or shifts to a music playing mode to play music based on using requirement.

To obtain the above objectives, a bluetooth communication and multimedia device contains: a body, a bluetooth receiving device, a display interface unit, a conversion communication unit, a music shifting unit, an email unit, an audio unit, a clock alarming unit, and a controlling unit.

The body includes a showing unit disposed on a first predetermined position thereof.

The bluetooth receiving device is mounted on a second predetermined position of the body and matches with a bluetooth system built in a cellular phone by ways of bluetooth.

The display interface unit is fixed on a third predetermined position of the body and connects with the bluetooth receiving device; wherein the display interface unit includes a waterproof panel, a plurality of watertight buttons, a waterproof microphone, and a watertight speaker.

The conversion communication unit is secured on the display interface unit and has an answering unit.

The music shifting unit is disposed on the display interface unit and has a playing unit.

The email unit is mounted on the display interface unit.

The audio unit is fixed on the display interface unit.

The clock alarming unit is secured on the display interface unit.

The controlling unit is disposed in the body and used to control the bluetooth receiving device, the display interface unit, the conversion communication unit, the music shifting unit, the email unit, the audio unit, and the clock alarming unit.

### BRIEF DESCRIPTION OF THE DRAWINGS

FIG. 1 is a perspective view showing the assembly of a bluetooth communication and multimedia device of a shower column according to a preferred embodiment of the present invention.

FIG. 2 is a plan view showing the operation of the bluetooth communication and multimedia device of the shower column according to the preferred embodiment of the present invention.

FIG. 3 is a flow chart showing the operation of the bluetooth communication and multimedia device of the shower column according to the preferred embodiment of the present invention.

FIG. 4 is another flow chart showing the operation of the bluetooth communication and multimedia device of the shower column according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

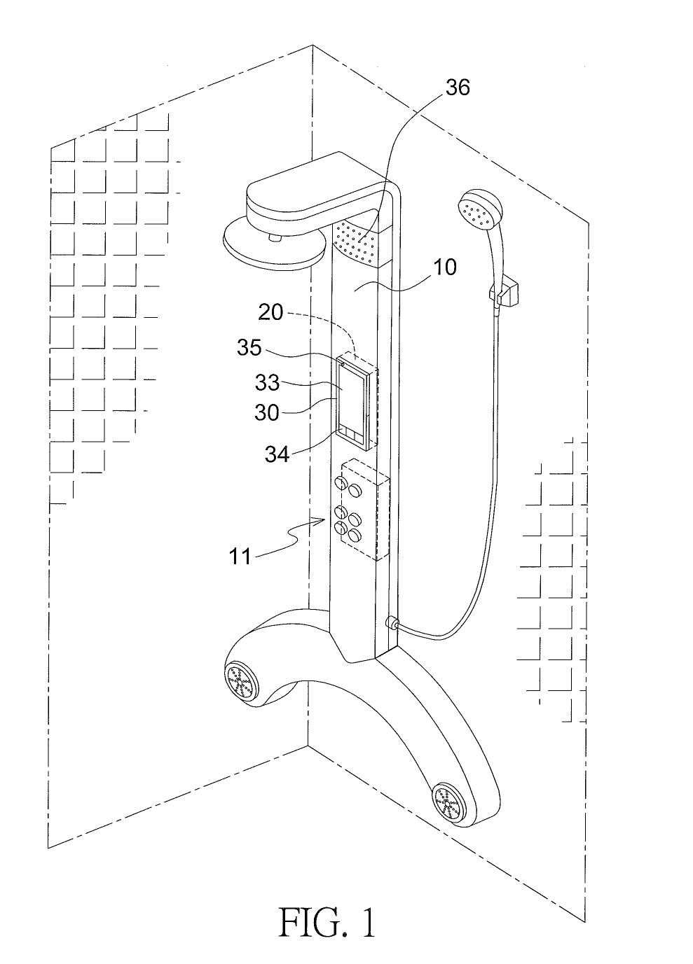

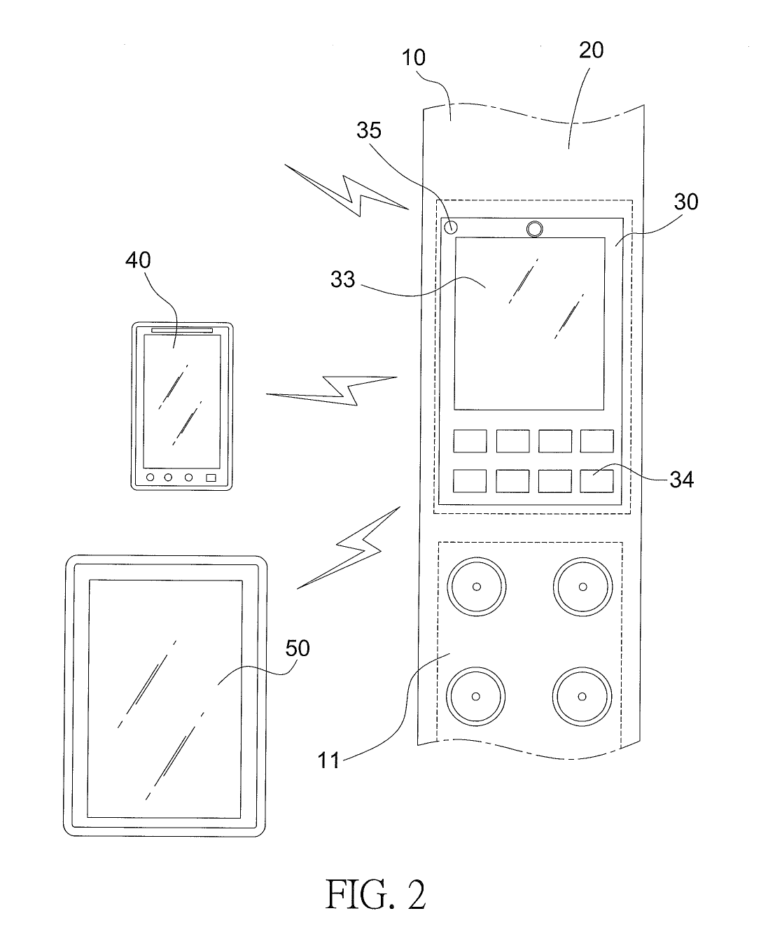

With reference to FIGS. 1-4, a bluetooth communication and multimedia device of a shower column according to a preferred embodiment of the present invention comprises:

a body 10 including a showing unit 11 disposed on a first predetermined position thereof;

a bluetooth receiving device 20 mounted on a second predetermined position of the body 10 and pairing with a bluetooth system built in a cellular phone 40 by ways of bluetooth;

a display interface unit 30 fixed on a third predetermined position of the body 10 and connecting with the bluetooth receiving device 20; wherein the display interface unit 30 includes a waterproof panel 33, a plurality of watertight buttons 34, a waterproof microphone 35, and a watertight speaker 36;

a conversion communication unit 31 secured on the display interface unit 30 and having an answering unit 311;

a music shifting unit 32 disposed on the display interface unit 30 and having a playing unit 321;

an email unit 37 mounted on the display interface unit 30;

an audio unit 38 fixed on the display interface unit 30;

a clock alarming unit 39 secured on the display interface unit 30;

a controlling unit 60 disposed in the body 10 and used to control the bluetooth receiving device 20, the display interface unit 30, the conversion communication unit 31, the music shifting unit 32, the email unit 37, the audio unit 38, and the clock alarming unit 39.

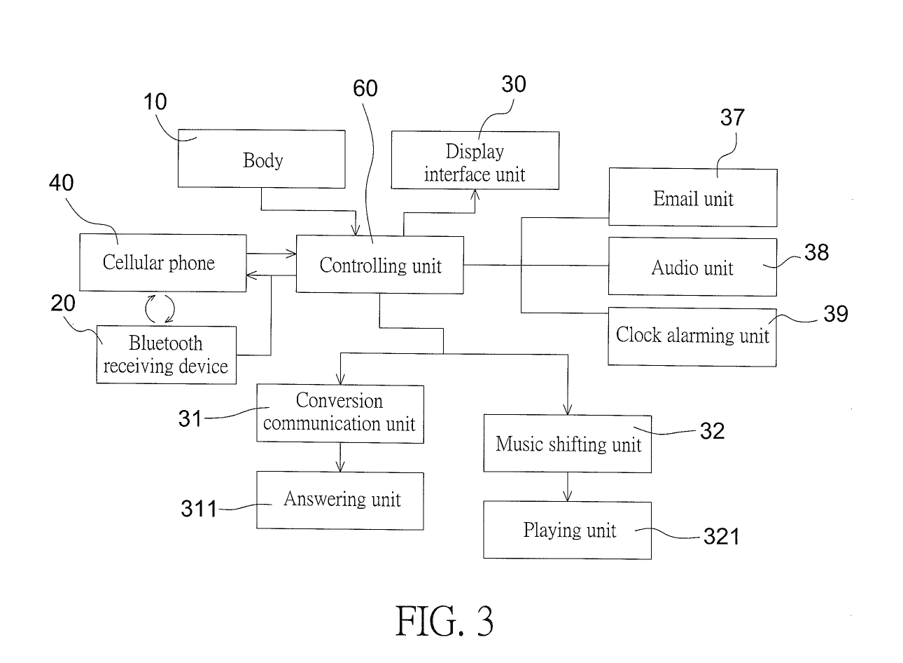

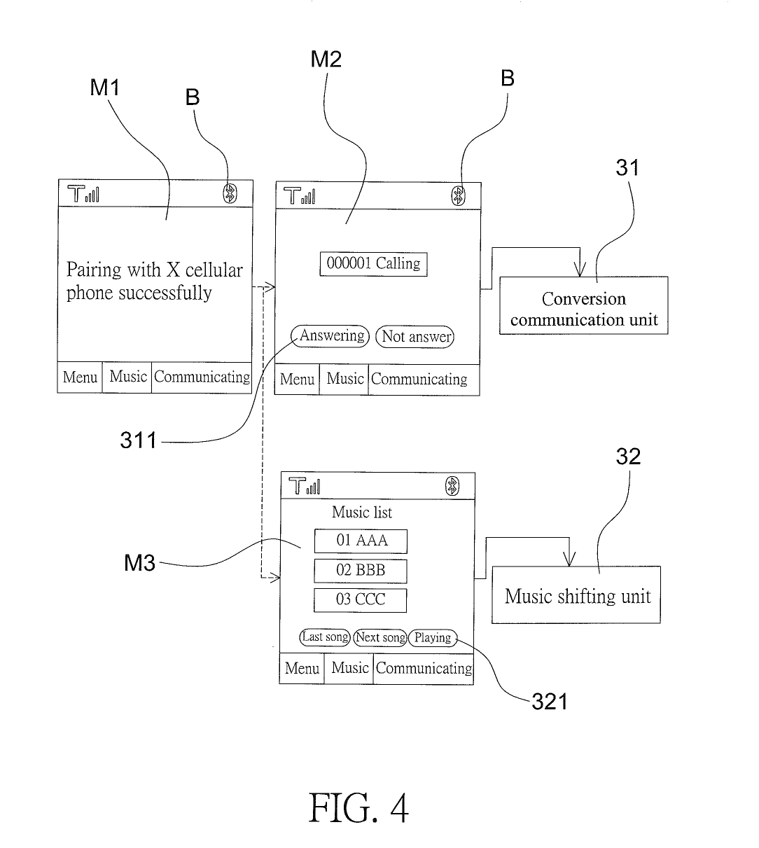

As shown in FIGS. 3 and 4, after the bluetooth system of the cellular phone 40 or a tablet computer 50 matches with the bluetooth receiving device 20, the display interface unit 30 displays a pairing success menu M1 and a bluetooth signal icon B at an upper right corner thereof. When the cellular phone 40 or the tablet computer 50 is called, a calling signal is transmitted to the bluetooth receiving device 20 in a bluetooth wireless transmission manner, and then the calling signal is transmitted to the conversion communication unit 31 of the display interface unit 30 from the bluetooth receiving device 20 so as to display the communication transforming screen M2 to notify a user, and the user answers a call, thereafter the controlling unit 60 controls the answering unit 311 to answer the cellular phone 40 or the tablet computer 50 via the waterproof microphone 35 and the watertight speaker 36.

As desiring to listen music, the display interface unit 30 is manually shifted to the music shifting unit 32 by the user so that the music shifting unit 32 displays a music shifting unit M3 to notify the user, and then the controlling unit 60 controls the playing unit 321 to contact with a music database of the cellular phone 40 or the tablet computer 50 so as to play a music which is chosen by the user by ways of the watertight speaker 36.

Thereby, the bluetooth receiving device 20 of the body 10 receives the calling signal by using the cellular phone 40 or the tablet computer 50 in the bluetooth wireless transmission manner, and the body 10 provides information services so that the user receives the call or shifts to a music playing mode to play music based on using requirement.

While we have shown and described various embodiments in accordance with the present invention, it is clear to those skilled in the art that further embodiments may be made without departing from the scope of the present invention.

What is claimed is:

1. A bluetooth communication and multimedia device of a shower column comprising:
a body including a showing unit disposed on a first predetermined position thereof;
a bluetooth receiving device mounted on a second predetermined position of the body and pairing with a bluetooth system built in a cellular phone by ways of bluetooth;
a display interface unit fixed on a third predetermined position of the body and connecting with the bluetooth receiving device;
a conversion communication unit secured on the display interface unit and having an answering unit;
a music transforming unit disposed on the display interface unit and having a playing unit;
an email unit mounted on the display interface unit;
an audio unit fixed on the display interface unit;
a clock alarming unit secured on the display interface unit;
a controlling unit disposed in the body and used to control the bluetooth receiving device, the display interface unit, the conversion communication unit, the music transforming unit, the email unit, the audio unit, and the clock alarming unit.

2. The bluetooth communication and multimedia device of the shower column as claimed in claim 1, wherein the display interface unit includes a waterproof panel, a plurality of watertight buttons, a waterproof microphone, and a watertight speaker.
